(19) United States
(12) Patent Application Publication
(10) Pub. No.: US 2012/0268438 A1
(43) Pub. Date: Oct. 25, 2012

(54) DISPLAY WITH A REFLECTIVE LC PANEL, AND THE DISPLAY METHOD

(75) Inventor: Woo Cheol LEE, Suwon-si (KR)

(73) Assignee: SAMSUNG ELECTRONICS CO. LTD., Suwon-si (KR)

(21) Appl. No.: 13/454,501

(22) Filed: Apr. 24, 2012

(30) Foreign Application Priority Data
Apr. 25, 2011 (KR) 10-2011-0038178

(51) Int. Cl. G09G 3/36; G06F 3/038; G02F 1/13357

(52) U.S. Cl. 345/207; 349/67; 345/87

(57) ABSTRACT

A display includes a reflective Liquid Crystal (LC) panel having an LC layer, an optical unit having a light source, and a transmission plate unit stacked on the reflective LC panel. The transmission plate unit includes a first transmission plate and a second transmission plate that have respective and different indexes of refraction. Light incident on a first side of the first transmission plate is totally internally-reflected by a boundary between the first transmission plate and the second transmission plate, and travels through the first transmission plate to the reflective LC panel. The LC layer of the reflective LC panel reflects the incident light of spectra corresponding to pixel signals in order to display a video.

### PRIORITY

This application claims the benefit under 35 U.S.C. §119(a) of a Korean patent application filed on Apr. 25, 2011 in the Korean Intellectual Property Office and assigned Serial No. 10-2011-0038178, the entire disclosure of which is hereby incorporated by reference.

### BACKGROUND OF THE INVENTION

1. Field of the Invention

The present invention relates to display systems, and more particularly, to a display with a reflective Liquid Crystal (LC) panel and a display method using the reflective LC panel.

2. Description of the Related Art

Display devices, which are variously referred to as displays, display panels, display units, etc., may be equipped with Plasma Display Panels (PDPs) or LC panels. In recent years, display devices have been developed so as to employ Organic Lighting Emitting Diodes (OLEDs) having an emissive electroluminescent layer that is a film of organic compounds for emitting light in response to an electric current. Unlike display devices with OLEDs, displays with LC panels use back lights to provide external light sources providing emitted light. Displays having the LC panels that include the back lights are referred to as reflective Liquid Crystal Displays (LCDs).

Currently, transparent displays employing PDPs and OLEDs are being researched and developed. Accordingly, there is a need for such displays to be developed with the use of reflective LC panels.

### SUMMARY OF THE INVENTION

Aspects of the present invention are to address at least the above-mentioned problems and/or disadvantages and to provide at least the advantages described below. Accordingly, an aspect of the present invention is to provide a display with a reflective Liquid Crystal (LC) panel that operates as a reflective LC Display (LCD) in a video display mode and as a transparent display in a transparent display mode, using light transmission and reflection properties of the reflective LC panel, respectively.

Another aspect of the present invention is to provide a display method using the transparent display.

In accordance with an aspect of the present invention, a display is provided. The display includes a reflective Liquid Crystal (LC) panel with an LC layer, an optical unit having a light source, and a transmission plate unit having a first transmission plate and a second transmission plates that have respective and different indexes of refraction and are stacked on the reflective LC panel. The transmission plate unit receives light from the optical unit via a first side of the first transmission plate unit, allows the light to be totally reflected between the first and second transmission plates and transmits the light so as to be incident on the reflective LC panel. The reflective LC panel reflects the incident light of a spectrum corresponding to a pixel signal.

In accordance with another aspect of the present invention, a display is provided. The display includes a reflective Liquid Crystal (LC) panel having an LC layer, an optical unit having a light source, a transmission plate unit having a first transmission plate and a second transmission plate that have different and respective indexes of refraction and which are stacked on the reflective LC panel, a sensor for sensing an intensity of illumination of light near the reflective LC panel, and a controller for controlling the reflective LC panel to operate in at least one of a video display mode with a LC of the LC layer being in a planar state and a transparent display mode with the LC of the LC layer being in a homeotropic state, and for turning on or off the optical unit according to intensity of illumination of light near the reflective LC panel as sensed by the sensor, and a driver Integrated Circuit (IC) for driving the reflective LC panel to be in the at least one of the video display mode and the transparent mode according to a control of the controller.

In accordance with another aspect of the present invention, a display method of a display that includes a reflective Liquid Crystal (LC) panel having an LC layer, an optical unit having a light source, a transmission plate unit for transmitting light of the optical unit, and a sensor for sensing an intensity of illumination of light near the reflective LC panel is provided. The method includes determining a display mode of the display to be one of a video display mode and a transparent mode, and controlling the reflective LC panel to operate in a planar state if the display mode is the video display mode. The controlling of the reflective LC panel to operate in the planar state includes sensing an intensity of illumination of light near the reflective panel using the sensor, comparing the sensed intensity of illumination of light with a reference value, turning off the optical unit to operate the reflective LC panel using a peripheral light when the sensed intensity of illumination of light is greater than the reference value, and turning on the optical unit to operate the reflective LC panel using light output from the optical unit when the sensed intensity of illumination of light is less than the reference value.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a side view of a display according to an exemplary embodiment of the present invention;

FIG. 2 illustrates a configuration of a reflective Liquid Crystal (LC) panel of the display shown in FIG. 1 according to an exemplary embodiment of the present invention;

FIG. 3 illustrates a transmission plate unit of the display shown in FIG. 1 according to an exemplary embodiment of the present invention;

FIG. 4 illustrates a view that describes optical paths in a display with the reflective LC panel shown in FIG. 2 and the transmission plate unit shown in FIG. 3 according to an exemplary embodiment of the present invention;

FIG. 5 illustrates a schematic block diagram showing a display according to an exemplary embodiment of the present invention; and

FIG. 6 illustrates a flow chart that describes a display method of a display, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to the exemplary embodiments of the present invention, the display includes a reflective Liquid Crystal (LC) panel, a transmission plate unit, the transmission plate unit having two transmission plates with different and respective indexes of refraction and disposed on the reflective LC panel, and an optical unit for providing light to the transmission plate unit. The optical unit provides light to a side of one of the transmission plates. The transmission plates allow the incident light to travel between the two transmission plates such that the incident light is totally reflected by the reflective LC panel, so that a video may be displayed on the reflective LC panel according to the light. Alternatively, the display can be operated in such a way that the reflective LC panel is transparent according to a control of a LC layer. In such a case, the user may view a displayed image through the reflective LC panel of the display. When the display is in an environment where peripheral light (e.g., light from the sun or an artificial light source such as florescent lights) is sufficiently bright, the display turns off the optical unit and instead allows the reflective LC panel to operate via the peripheral light.

The reflective LC panel may include an LC layer for reflecting light of spectra, walls for partitioning the LC layer, a first electrode and switching devices which are below the LC layer and the partition walls for driving the LC layer, and a transparent substrate below the first electrode and the switching devices. The reflective LC layer may include a second electrode for establishing electrical fields or an Electromagnetic Field (EMF) with the first electrode, the second electrode being located above the partition walls and the LC layer so as to be correspondingly paired with the first electrode, and a second substrate on the second electrode. In an exemplary embodiment of the present invention, the LC layer for reflecting light of spectra may be formed with cholesteric LC, and the switching device may be implemented with a series of transistor devices. However, the present invention is not limited thereto, and the LC layer may be formed of any suitable material and the switching device may be implemented with any suitable type of device.

The transmission plate unit may have two transmission plates, each respectively having different indexes of refraction, wherein the two transmission plates are referred to as a first transmission plate and a second transmission plate. The transmission plates may be closely coupled to each other, and the first transmission plate may have a larger index of refraction than the second transmission plate. The light incident on the side of the first transmission plate may be totally reflected from the second transmission plate so as to then travel through the first transmission plate to the reflective LC panel.

The display is configured in such a way that the second transmission plate having a respective index of refraction is aligned in a predetermined manner, the first transmission plate having a larger index of refraction than the second transmission plate is disposed on the second transmission plate, an auxiliary light source is aligned at a side of the second transmission plate, and a reflective LC layer is formed on the first transmission plate. Light from the auxiliary light source may be totally reflected by the second transmission plate so as to travel through the first transmission plate towards the reflective LC layer, thereby displaying a video and an image on the reflective LC panel.

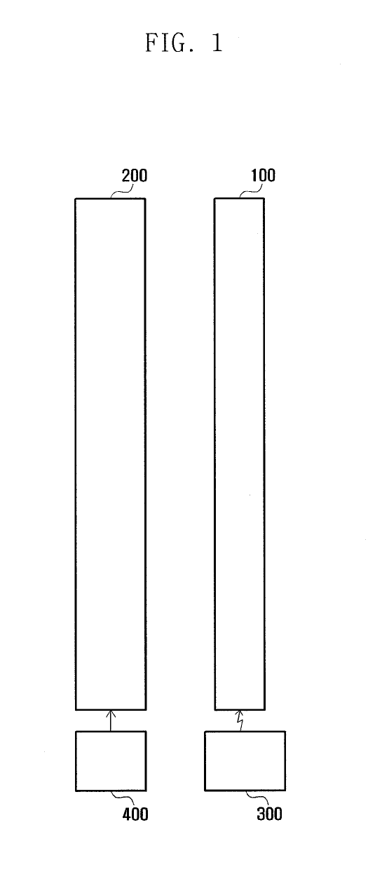

FIG. 1 illustrates a side view of a display according to an exemplary embodiment of the present invention.

Referring to FIG. 1, the display includes a reflective LC panel 200, a driver Integrated Circuit (IC) 400 located below the reflective LC panel 200, a transmission plate unit 100 disposed in the front of the reflective LC panel 200, and an optical unit 300 located below the transmission plate unit 100. The optical unit 300 emits light towards the side of the transmission plate unit 100. The transmission plate unit 100 provides total internal reflection of the incident light and transfers it to the reflective LC layer. The reflective LC panel 200 displays a video and an image by transmitting or reflecting light according to the signals of the driver IC 400. The reflective LC panel 200 allows for the transmission of light according to the signals output from the driver IC 400. As such, the user may view the video and images displayed through the reflective LC panel 200. Alternatively, when the display is in an environment where peripheral light (e.g., light from the sun, etc.) is sufficiently bright, the display turns off the optical unit 300 so as to allow the reflective LC panel 200 to operate via the peripheral light.

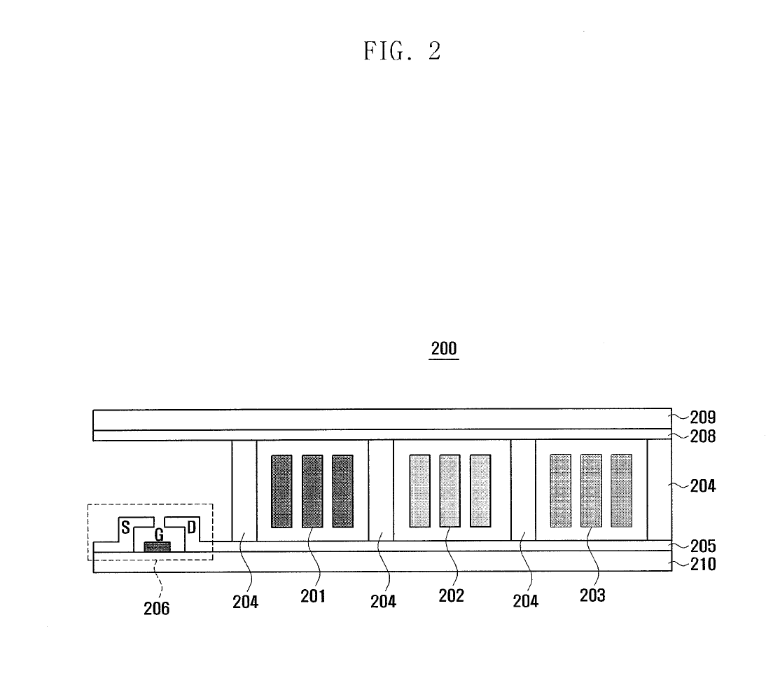

FIG. 2 illustrates a configuration of the reflective LC panel of the display shown in FIG. 1 according to an exemplary embodiment of the present invention.

Referring to FIG. 2 the reflective LC panel 200 includes an LC layer for reflecting light of spectra and disposed between walls 204 for partitioning the LC layer into LC sub-layers 201 to 203, each for respectively reflecting light of corresponding spectrum. The reflective LC panel 200 also includes a first electrode 205 and switching devices 206 that are disposed at a side (i.e., below) of both the LC sub-layers 201 to 203 and the partition walls 204 in order to drive the LC sub-layers 201 to 203. The reflective LC panel 200 includes a first transparent substrate 210 disposed below both the first electrode 205 and the switching devices 206. Additionally, the reflective LC panel 200 includes a second electrode 208 for establishing electric fields or an EMF in conjunction with the first electrode 205, wherein the second electrode 208 correspondingly paired with the first electrode 205 and is disposed above the partition walls 204 and the LC sub-layers 201 to 203. A second transparent substrate 209 is disposed on the second electrode 208. According to an exemplary embodiment of the present invention, the LC sub-layers 201 to 203 for reflecting light may be formed with cholesteric LC, and the switching devices 206 may be implemented with a series of transistor devices.

The LC sub-layers 201 to 203 respectively reflect light of one of red, green, and blue wavelengths. To this end, the LC sub-layers 201 to 203 have characteristics wherein a pitch, or angle, between the LC molecules is reduced according to an increase in temperature. Since the LC sub-layers 201 to 203 are implemented with cholesteric LC, they reflect circularly polarized light of a particular wavelength. The LC sub-layers 201 to 203 are driven by the switching devices 206 in order to perform display operations, such as reflection or transmission of light. The switching devices 206 are operated under a control of a driver IC 400. For example, the switching devices 206 may be implemented with transistors where, for each of the switching devices 206, respective drains are connected to the first electrode 205, respective sources are connected to a voltage source, and respective gates are connected to and controlled by the driver IC 400.

The first electrode 205 and the second electrode 208 may form electric fields in order to control an LC state. The first electrode 205 and second electrode 208 may be formed of Indium Tin Oxide (ITO), which is transparent material, or any other suitable material. The second electrode 208 is a common electrode. The LC sub-layers 201 to 203 are operated or driven according to a difference in electric potentials between an upper plate, i.e., the second electrode 208, and a lower plate, i.e., the first electrode 205. The upper plate includes the second electrode 208 as a common electrode formed as one electrode so that the second electrode 208 retains constant potential as a reference voltage. Pixels are independently formed on the lower plate so as to have contact with the first electrode 205. The LC sub-layers 201 to 203, as noted above, are driven by the difference between the electric potentials of the second electrode 208 and the first electrode 205 when a voltage applied to the first electrode 205 varies. The first transparent substrate 210 and the second transparent substrate 209 are made of a transparent material, such as plastic, glass, or any other suitable material that may be flexible.

The driver IC 400 is an IC chip that applies a voltage to a particular pixel from among a plurality of pixels in a two-dimensional display screen. The driver IC 400 is connected to row lines of the gates of respective ones of the plurality of pixels and column lines of the sources of respective ones of the plurality of pixels. The driver IC 400 receives commands for a voltage signal to be applied, locations of respective ones of the plurality of pixels, operations, or other similar commands and messages, from an LC controller (not shown). The driver IC 400 applies one voltage level to the gates of respective ones of the pixels that are disposed in a same row, thereby operating the switching devices 206 in a row-wise manner. In addition, the driver IC 400 selects a column line for the sources of respective ones of the plurality of pixels under the control of the LC controller, and applies another voltage level, which may be determined according to a gamma resistance, to the selected column line when the switching devices 206 are turned on in conjunction with the gates receiving the signal voltage from the gate line, thereby driving the pixels. Accordingly, the pixels are driven and a corresponding image is displayed on the screen.

The LC controller provides signals, such as an input digital pixel data, to the driver IC 400 which converts the input digital pixel data into analog data to be transferred to the display panel in a line by line manner. The source driver IC (not shown) provides voltage levels to be transferred to pixels in a line by line manner. The gate driver IC (not shown) provides voltage levels to the gates of the switching devices 206 in order to control the operation of the switching devices 206. The driver ICs are driven and controlled by signals that are generated by a timing control IC (not shown).

As shown in FIG. 2, the reflective LC panel 200 is configures so as to transmit circularly polarized light in a certain direction. When the reflective LC panel 200 is implemented with a left-linear polarization cholesteric LC, it transmits left-circularly polarized light and reflects right-circularly polarized light of a certain range of wavelength. On the contrary, when the reflective LC panel 200 is implemented with a right-linear polarization cholesteric LC, it transmits right-circularly polarized light and reflects left-circularly polarized light of a certain range of wavelength. According to the present exemplary embodiment of the present invention, for the sake of convenience herein, the reflective LC panel 200 transmits right-circularly polarized light and reflects left-circularly polarized light. However, the present invention is not limited thereto, and the LC panel 200 may also be implemented with various types of LCs other than cholesteric LC and may have any suitable type of polarization.

Cholesteric LCs may be in a variety of LC states, e.g., a planar state, a focal-conic state, and a homeotropic state, according to the electric fields or EMF between the first electrode 205 and the second electrode 208 of the reflective LC panel 200. The planar state refers to a state where a spiral axis of the cholesteric LC is vertically aligned with the first transparent substrate 210. The focal-conic state refers to a state where the spiral axis of the cholesteric LC is aligned to be parallel to the first transparent substrate 210. The LC state may be changed from the planar state to the focal-conic state by applying a voltage level to the LC layer so as to generate the appropriate electric field or EMF. When the LC layer receives another voltage level, a spiral structure of the LC is untwisted and thus the LC molecules are aligned in the direction of the electric field so as to be in the homeotropic state. According to the voltage level, the LC state varies between the planar, the focal-conic, and the homeotropic states. The reflectance of the LC depends on the LC state of the LC. For example, the reflectance of the LC is approximately 30% in the planar state, 3˜4% in the focal-conic state, and 0.5˜0.7% in the homeotropic state. In order to increase the performance of a transparent display, the reflectance should be low in an area of the screen that is not showing a video or an image, and thus, in such a case, the LC should be in a homeotropic state in the area of the screen that is not showing the video or the image. On the contrary, when displaying a video, the LC should be in a planar state.

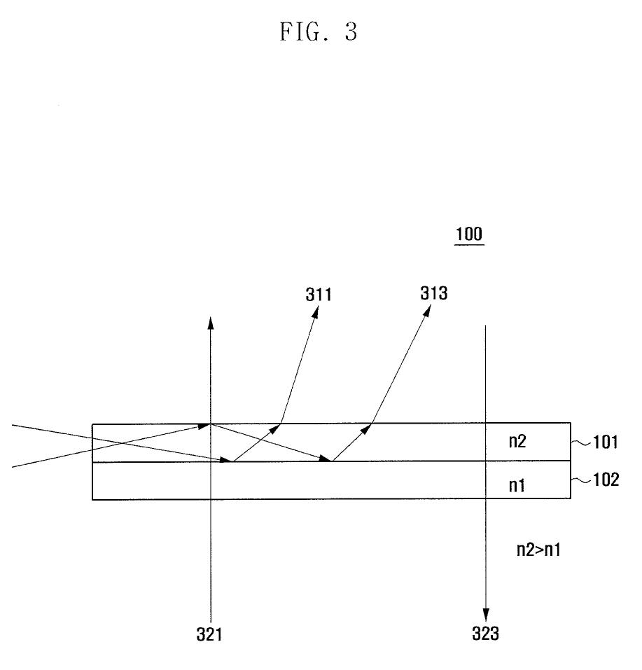

In general, cholesteric LC is in a planar state in order to display a video or an image, using light reflected from the outside, however, in a dark environment, the LC uses an external light source in order to display a video or an image. According to an exemplary embodiment of the present invention, the optical unit 300 and the transmission plate unit 100 are installed in front of the reflective LC panel 200 (i.e., above the reflective LC panel 200). In order to allow for a condition of external light reflection and transparency of the reflective LC panel 200, the transmission plate unit 100 is designed to have two different indexes of refraction as described below, with reference to FIG. 3.

FIG. 3 illustrates a transmission plate unit 100 of the display shown in FIG. 1 according to an exemplary embodiment of the present invention.

Referring to FIG. 3, the transmission plate unit 100 includes a first transmission plate 101 having an index of refraction n2, and a second transmission plate 102 having an index of refraction n1. The first transmission plate 101 is aligned to face or contact the reflective LC panel 200. The index of refraction n2 is greater than n1. In such a case, light beams 311 and 313, which are incident on a side of the first transmission plate 101 from a direction of the optical unit 300, are totally reflected by the second transmission plate 102 and travel through the first transmission plate 101 to the reflective LC panel 200. On the other hand, light beams 321 and 323, which are vertically incident on the first transmission plate 101 and the second transmission plate 102, travel through the first and second transmission plates 101 and 102 without being refracted.

According to another exemplary embodiment of the present invention, the transmission plate unit 100 may further include an optical device (not shown), such as a light screen tape, and/or a light screen print material, at a boundary between the optical unit 300 and the second transmission plate 102, so that the second transmission plate 102 is not subject to light beams incident on the side of the first transmission plate 101.

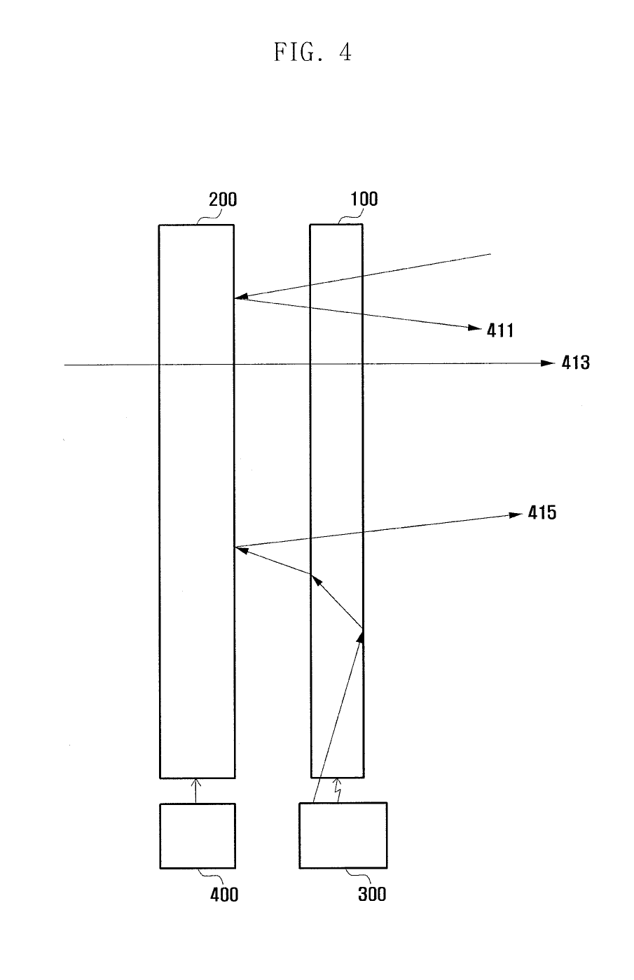

FIG. 4 illustrates a view that describes optical paths in a display with the reflective LC panel shown in FIG. 2 and the transmission plate unit shown in FIG. 3 according to an exemplary embodiment of the present invention. As shown in FIG. 4, the display allows light to travel via first through third optical paths 411, 413, and 415.

The first optical path 411 is a path where light incident on the transmission plate unit 100 from an external light source travels through the transmission plate unit 100 to the reflective LC panel 200 and then is reflected from the reflective LC panel 200. When light travels along the first optical path 411, the reflective LC panel 200 is operated in a planar state according to the driver IC 400. In such a case, the reflective LC panel 200 reflects light of a particular spectrum (e.g., red, green, and blue), via pixel signals from the driver IC 400, with a reflectance of 30%, thereby displaying a video or image via the transmission plate unit 100.

The second optical path 413 is a path where light incident on a backside of the reflective LC panel 200 from an external light source travels through the reflective LC panel 200 and the transmission plate unit 100. When the display allows light to travel along the second optical path 413, the reflective LC panel 200 of the display serves as a transparent LC panel. To this end, the driver IC 400 supplies a voltage level to the reflective LC panel 200 so that the LC is in a homeotropic state. In such a case, LC of the reflective LC panel 200 has a reflectance of approximately 0.5˜0.7%. Therefore, light is incident on the backside of the reflective LC panel 200 and travels through the reflective LC panel 200 and the transmission plate unit 100 without reflection.

The third optical path 415 is a path where light from an optical unit 300 is incident on the side of the transmission plate unit 100, is totally reflected via an internal side of the transmission plate unit 100, and travels through another internal side of the transmission plate unit 100 to the reflective LC panel 200. Since the transmission plate unit 100 includes a first transmission plate 101 having an index of refraction, n2, and a second transmission plate 102 having an index of refraction, n1, the transmission plate unit 100 has two indexes of refraction, n1 and n2. Thus, the light beams incident on the side of the first transmission plate 101 are totally reflected by the second transmission plate 102 and are output to the reflective LC panel 200 along the third optical path 415. When light travels along the third optical path 415, the reflective LC panel 200 is operated in a planar state according to the driver IC 400. In such a case, the reflective LC panel 200 reflects light of a particular spectrum (e.g., red, green, and blue) via pixel signals from the driver IC 400, thereby displaying a video or an image via the transmission plate unit 100.

As described above, the reflective LC panel 200 transmits or reflects the incident light according to the voltage levels provided by the driver IC 400. Since the reflective LC panel 200 is not self-emissive, it performs a display function via light from an external light source. Therefore, when the reflective LC panel 200 is used as a video or image display panel, it does not adequately display a video or an image when it does not receive light from peripheral or the external light sources. Thus, according to the present exemplary embodiments of the present invention, in order to adequately display the video or the image, the display includes a transmission plate unit 100 and an optical unit 300. The display controls the optical unit 300 according to the intensity of illumination of light from the peripheral or the external light sources, and provides light to the reflective LC panel 200 via the transmission plate unit 100.

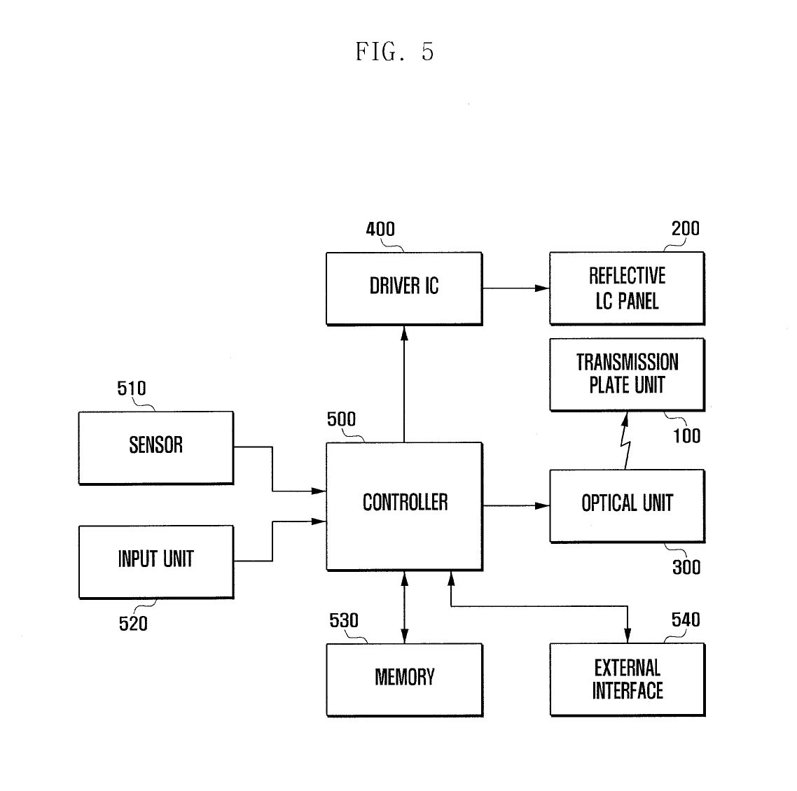

FIG. 5 illustrates a schematic block diagram showing a display according to an exemplary embodiment of the present invention.

The display includes a transmission plate unit 100, a reflective LC panel 200, an optical unit 300, a driver IC 400, a controller 500, a sensor 510, an input unit 520, a memory 530, and an external interface 540.

The reflective LC panel 200, which is described above with reference to FIG. 2, includes the driver IC 400 for driving the reflective LC panel 200 in an operation mode according to the controller 500. The driver IC 400 applies pixel data to the reflective LC panel 200 in a video display mode. The transmission plate unit 100 is described above with reference to FIG. 3.

The optical unit 300 includes a light source and provides light to the side of the transmission plate unit 100, as discussed above with reference to FIGS. 1 and 4. Light incident on the side of the first transmission plate 101 is totally internal-reflected via the second transmission plate 102 due to the difference between the respective indexes of refraction, n2 and n1, of the first 101 and second 102 transmission plates, and travels through the first transmission plate 101 to the reflective LC panel 200.

The input unit 520 generates a key command for controlling the operation modes of the display. For example, the key command is a command for operating the display in a transparent display mode or a video display mode. The sensor 510 is disposed on or close to the reflective LC panel 200. The sensor 510 senses an intensity of illumination near the reflective LC panel 200. According to an exemplary embodiment of the present invention, the sensor 510 is implemented with an illumination sensor. However, the present invention is not limited thereto, and any suitable sensor for sensing an intensity of illumination or amount of light may be used as the sensor 510.

The external interface 540 is connected to an external system and receives video or image data therefrom. The external interface 540 may be a short-range wireless communication interface or a wired communication interface. For example, the wired communication interface may be a Universal Serial Bus (USB) interface, or any other suitable wired interface, and the wireless communication interface may be anyone of a Bluetooth communication interface, an Ultra-Wide Band (UWB) communication interface, a Near Field Communication (NFC) interface, a Radio Frequency (RF) communication interface, such as a WiFi communication interface, or any other suitable wireless communication interface. The external interface 540 connects with an external system so that the display transmits and/or receives data such as video and image data to and/or from the external system. The controller 500 receives data via the external interface 540 and stores it in the memory 530 or transfers it to the driver IC 400.

The memory 530 stores an application program for operating the display. The memory 530 also stores reference data for operating the optical unit 300 according to the intensity of illumination near the display. The reference data may be illumination intensity data.

The controller 500 controls the operation of the display. The controller 500 may include a video processor and other similar elements for the processing of video and image data. The controller 500 may receive video and image data from an external system via the external interface 540. The controller 500 may control the reflective LC panel 200 to be in a transparent display mode or a video display mode according to a user's selection of a display mode. The controller 500 may control the optical unit 300 according to the output of the sensor 510, and provide light from the optical unit 300 to the reflective LC panel 200.

The controller 500 receives a command that the user inputs via the input unit 520, and controls the driver IC 400 to operate the reflective LC panel 200 in a transparent display mode or a video display mode according to the user's input command corresponding to the selected display mode. The controller 500 controls the driver IC 400 to provide different voltage levels to the first electrode 205 and the second electrode 208 of the reflective LC panel 200. That is, when the display is set to operate in the video display mode, the controller 500 controls the driver IC 400 to provide a voltage level to the reflective LC panel 200 so that the cholesteric LC in the sub-layers 201 to 203 is in a planar state. Likewise, when the display is set to operate in the transparent display mode, the controller 500 controls the driver IC 400 to provide a voltage level to the reflective LC panel 200 so that cholesteric LC in the sub-layers 201 to 203 is in a homeotropic state.

When the reflective LC panel 200 operates in a video display mode, the controller 500 receives a signal corresponding to the intensity of illumination of light near the display from the sensor 510. The controller 500 compares the intensity of illumination of light sensed by the sensor 510 with a reference value stored in the memory 530 in order to determine whether the intensity of illumination of light near the reflective LC panel 200 is greater than a preset level of brightness corresponding to the stored reference value. In a case where the controller 500 determines that the intensity of illumination of light sensed by the sensor 510 is less than the stored reference value, i.e., the amount of light sensed to be around the reflective LC panel 200 is less a preset level of brightness, the controller 500 drives the optical unit 300. In such a case, the light source in the optical unit 300 provides light to the transmission plate unit 100, in which the incident light is totally internal-reflected so as to travel through the reflective LC panel 200. Accordingly, when the display is used in a dark environment having a low amount of light sensed by the sensor 510, such as a nighttime or indoors environment, then the controller 500 can operate the reflective LC panel 200 in a video display mode.

The optical unit 300 may be manually controlled irrespective of the intensity of illumination sensed by the sensor 510. The input unit 520 may include an operation key for manually controlling the optical unit 300. When the user operates the key, the controller turns on the optical unit 300 according to the user's input rather than according to an amount of light sensed by the sensor 510. That is, although the display is placed in an environment where the intensity of illumination of light is large, the user may manually turn on the optical unit 300. Furthermore, although it is not shown in FIG. 5, the display may further include an audio processing unit with a speaker that processes the received audio data.

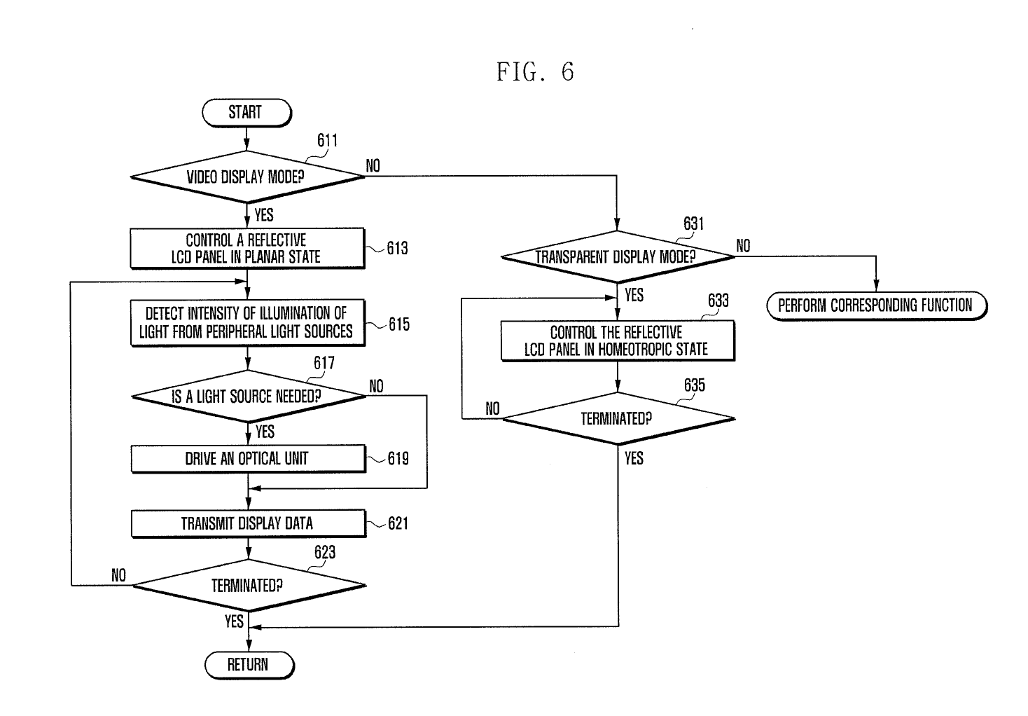

FIG. 6 illustrates a flow chart that describes a display method of the display, according to an exemplary embodiment of the present invention.

Referring to FIG. 6, the user operates the reflective LC panel 200 in a video display mode or a transparent display mode via the input unit 520. In step 611, the controller 500 determines whether the reflective LC panel 200 is set in a video display mode and controls the reflective LC panel 200 to be operated in a planar state via the driver IC 400 in step 613 if the video display mode is set. When the reflective LC panel 200 is controlled to be operated in the planar state, then the reflectance of the reflective LC panel 200 increases. In further detail, the LC layer corresponding to pixel data being displayed reflects the external incident light because the cholesteric LC reflects externally incident light in a planar state. As such, when in the planar state, the LC panel 200 does not use natural light in an environment where there is no light, i.e., it is dark or the LC panel 200 is indoors, and instead, uses light generated by a light source.

Upon the LC panel 200 being operated in the planar state, then, in step 615, controller 500 receives an output of the sensor 510. The controller 500 then analyzes the intensity of illumination of light near the reflective LC panel 200 and determines whether it needs a light source in step 617. That is, the controller 500 compares the intensity of illumination of light near the reflective LC panel 200 with a reference value at step 617, and determines the intensity of illumination of light in comparison to the reference value. Light near the reflective LC panel 200 may be natural light or light created by a light source (e.g., an electric light, etc.). The reference values for the intensity of illumination may be stored in a table in the memory 530. The sensor 510 may be an illumination sensor. In that case, the reference values are intensities of illumination. However, the present invention is not limited thereto, and a variety of suitable sensors and corresponding types of reference values may be used.

When it is determined in step 617 that a light source is needed, then in step 619, the controller 500 drives an optical unit. On the other hand, when it is determined in step 617 that a light source is not needed, the display method proceeds to step 621 and skips step 619. In step 621, in a case where the optical unit is not driven in step 619, the controller 500 transfers pixel data to be displayed via the driver IC 400 so that the reflective LC panel 200 displays the input pixel signals via the peripheral light. As shown in FIG. 4, along the optical path 411, peripheral light, which is incident on the transmission plate unit 100 from the external light source, travels though the transmission plate unit 100 and then the light reflects towards the LC layer of the reflective LC panel 200. In such a case, the reflective LC panel 200 is operated in a planar state. In addition, the reflective LC panel 200 is operated in such a way that the sub-layers 201 to 203 corresponding to pixel signals from the driver IC 400 reflect light beams of a spectra (e.g., red, green, and blue), and the reflected light travels through the transmission plate unit 100 in order to display a video or an image. The video or image is displayed until the user inputs a command for interrupting displaying the video, and in step 623, the controller 500 determines whether the user has input a termination command and interrupts or continues displaying the video according to the user's input.

Returning to step 617, in the case where the controller 500 determines that the light source is needed, then in step 619, the controller 500 operates the optical unit 300 in order to provide light to the reflective LC panel 200. In such a case, light from the optical unit 300 is incident on the side of the transmission plate unit 100, as shown in FIG. 3 and discussed above with reference to FIG. 3. Then, in step 621, the controller 500 transmits pixel signals to the reflective LC panel 200 via the driver IC 400 So that the reflective LC panel 200 outputs the input pixel signals via light output from the optical unit 300.

As discussed above, when the reflective LC panel 200 is in a dark environment, the optical unit 300 is operated in order to provide light to the side of the transmission plate unit 100. Light incident on the transmission plate unit 100 is totally internally-reflected therein and then travels through the reflective LC panel 200. Light incident on the side of the first transmission plate 101 is totally internal-reflected via the boundary between the first transmission plate 101 and the second transmission plate 102 due to their respective and different indexes of refraction, and then travels though the reflective LC panel 200 so that the reflected light travels through the transmission plate unit 100 and displays a video or an image.

Returning to step 611, when the controller 500 determines that the reflective LC panel 200 is not operated in a video display mode, for example, in a case where the user inputs a command for operating a transparent display mode at step 611, then the controller 500 detects a transparent display mode command in step 631 and then controls the reflective LC panel 200 to operate in a homeotropic state in step 633. In such a case, the display allows light to travel through the reflective LC panel 200 and the transmission plate unit 100, along the optical path 413 as shown in FIG. 4. In further detail, the user may be able to see through the reflective LC panel 200 and the transmission plate unit 100 because the reflective LC panel 200 is operated to be transparent. The transparent display mode is retained until a command for interrupting operating the transparent display mode is detected in step 635. For example, when the user inputs a command for interrupting the operating of the transparent display mode, the controller 500 detects the command and determines to interrupt or halt the transparent display mode.

As discussed above, with reference to FIG. 4, when the display operates in a transparent display mode, light travels along the optical path 413 and thus the reflective LC panel 200 serves as a transparent display panel. In such a case, the reflective LC panel 200 receives a level of voltage via the driver IC 400 so that the LC is changed to be in and operated in a homeotropic state. In addition, the reflectance in a homeotropic state should be reduced to a value much lower than in a planar state. For example, according to an exemplary embodiment, the reflectance in the homeotropic state is approximately 0.5% to 0.7% of the reflectance in the planar state. In such a case, light incident on a backside of the reflective LC panel 200 travels through the reflective LC panel 200 and the transmission plate unit 100, without reflection. Therefore, the reflective LC panel 200 can serve as a transparent panel.

Although the exemplary embodiment illustrated in FIG. 6 describes the method where the display operates in a video display mode or a transparent display mode, the present invention is not limited thereto, and the display may be operated so as to simultaneously operate in the video display mode and the transparent display mode. In such a case, the controller 500 provides the reflective LC panel 200 with a drive voltage level so as to be between a drive voltage level for the video display mode (wherein the LC layer is in a planar state) and a drive voltage level for the transparent display mode (wherein the LC layer is in a homeotropic state), thereby implementing both the video display mode and the transparent display mode.

As described above, the display according to the present exemplary embodiments of the present invention is operated in such a way that the LC panel is transparent in a transparent display mode and the LC panel operates as a reflective LC panel, via light of an external light source or the peripheral light, according to the brightness, in video display mode. When the external light source is turned on, the display reflects light of the backlight to the LC layer, via the total reflection by the two refractive layers, in order to display a video. The display according to the present exemplary embodiment of the present invention may be applied to transparent displays, heads-up displays for systems such as vehicles, helmets, eyeglasses, or other similar applications using transparent displays. The display may also be installed to indoor and outdoor windows, display signs, display screens, advertisement signs, and other similar applications, so that they may be operated in a transparent display mode or a video display mode.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A display comprising:
a reflective Liquid Crystal (LC) panel having an LC layer;
an optical unit having a light source; and
a transmission plate unit having a first transmission plate and a second transmission plate that have respective and different indexes of refraction and are stacked on the reflective LC panel,
wherein the transmission plate unit receives light from the optical unit via a first side of the first transmission plate unit, allows the light to be totally reflected between the first and second transmission plates and transmits the light so as to be incident on the reflective LC panel, and
wherein the reflective LC panel reflects the incident light of a spectrum corresponding to a pixel signal.

2. The display of claim 1, wherein the first transmission plate and the second transmission plate are coupled to each other, and
wherein the first transmission plate has a first index of refraction that is larger than a second index of refraction of the second transmission plate, so that light incident on the first side of the first transmission plate is totally internally-reflected by the second transmission plate so as to travel through the first transmission plate to the reflective LC panel.

3. The display of claim 2, wherein the transmission plate unit comprises an optical device disposed at a boundary between the optical unit and the second transmission plate in order to block light incident on the first side of the first transmission plate from being incident on the second transmission plate, and
wherein the optical device is at least one of a light screen tape, a light screen print material, and a light blocking tape.

4. The display of claim 2, wherein the reflective LC panel comprises:
sub-layers for reflecting light of a spectra of the light source;
partition walls for separating the sub-layers;
a first electrode and a second electrode located respectively at an upper side and a lower side of the sub-layers and the partition walls, for providing a voltage to the sub-layers; and
switching devices, connected to the first transmission plate, for driving the sub-layers,
wherein the first transmission plate is connected to a lower side of the first electrode, and
wherein the second transmission plate is connected to an upper side of the second electrode.

5. The display of claim 4, wherein the sub-layers comprise cholesteric LC for reflecting light of the spectra.

6. The display of claim 5, wherein the switching devices are transistors.

7. The display of claim 1, wherein the optical unit is operated according to a control of a user of the display.

8. A display comprising:
a reflective Liquid Crystal (LC) panel having an LC layer;
an optical unit having a light source;
a transmission plate unit having a first transmission plate and a second transmission plate that have different and respective indexes of refraction and which are stacked on the reflective LC panel;
a sensor for sensing an intensity of illumination of light near the reflective LC panel;
a controller for controlling the reflective LC panel to operate in at least one of a video display mode with a LC of the LC layer being in a planar state and a transparent display mode with the LC of the LC layer being in a homeotropic state and for turning on or off the optical unit according to the intensity of illumination of light near the reflective LC panel as sensed by the sensor; and
a driver Integrated Circuit (IC) for driving the reflective LC panel to be in the at least one of the video display mode and the transparent mode according to a control of the controller.

9. The display of claim 8, wherein, when the reflective LC panel is operated in the transparent mode, the controller controls the reflective LC panel so as to allow light to travel through the reflective LC panel, and
wherein, when the reflective LC panel is operated in the video display mode, the controller turns off the optical unit when the intensity of illumination of light near the reflective LC panel is greater than a reference value so as to allow the reflective LC panel to operate using peripheral light, and
wherein, when the reflective LC panel is operated in the video display mode, the controller turns on the optical unit when the intensity of illumination of light near the reflective LC panel is less than the reference value so as to allow the reflective LC panel to operate using light output from the light source of the optical unit.

10. The display of claim 9, wherein the first transmission plate and the second transmission plate are coupled to each other, and
wherein the index of refraction of the first transmission plate is greater than the index of refraction of the second transmission plate so that light incident on a first side of the first transmission plate is totally internally-reflected by the second transmission plate so as to travel through the first transmission plate to the reflective LC panel, and
wherein the transmission plate unit receives light from the optical unit via the first side of the first transmission plate unit, allows the received light to be totally reflected between the first transmission plate and the second transmission plate and transmits the light to be incident on the reflective LC panel, and
wherein the reflective LC panel reflects the incident light of a spectrum corresponding to a pixel signal.

11. The display of claim 10, wherein the transmission plate unit comprises an optical device disposed at a boundary between the optical unit and the second transmission plate in order to block light incident on the first side of the first transmission plate from being incident on the second transmission plate, and
wherein the optical device is at least one of a light screen tape, a light screen print material, and a light blocking tape.

12. The display of claim 10, wherein the reflective LC panel comprises:
sub-layers for reflecting light of a spectra of the light source;
partition walls for separating the sub-layers;
a first electrode and a second electrode located respectively at an upper side and a lower side of the sub-layers and the partition walls, for providing a voltage to the sub-layers; and
switching devices, connected to the first transmission plate, for driving the sub-layers,
wherein the first transmission plate is connected to a lower side of the first electrode, and
wherein the second transmission plate is connected to an upper side of the second electrode.

13. The display of claim 12, wherein the sub-layers comprise cholesteric LC for reflecting light of the spectra.

14. The display of claim 8, wherein the controller controls the optical unit to be on or off according to a user input.

15. A display method of a display that includes a reflective Liquid Crystal (LC) panel having an LC layer, an optical unit having a light source, a transmission plate unit for transmitting light of the optical unit, and a sensor for sensing an intensity of illumination of light near the reflective LC panel, the method comprising:
determining a display mode of the display to be one of a video display mode and a transparent mode; and
controlling the reflective LC panel to operate in a planar state if the display mode is the video display mode,
wherein the controlling of the reflective LC panel to operate in the planar state comprises:
sensing an intensity of illumination of light near the reflective panel using the sensor;
comparing the sensed intensity of illumination of light with a reference value;
turning off the optical unit to operate the reflective LC panel using a peripheral light when the sensed intensity of illumination of light is greater than the reference value; and
turning on the optical unit to operate the reflective LC panel using light output from the optical unit when the sensed intensity of illumination of light is less than the reference value.

16. The method of claim 15, further comprising:
controlling the reflective LC panel to operate in a homeotropic state if the display mode is in a the transparent display mode;
wherein the controlling of the reflective LC panel to operate in the homeotropic state comprises allowing light to travel through the reflective LC panel.

17. The method of claim 16, further comprising:
forming the transmission plate unit to have a first transmission plate and a second transmission plate that are coupled to each other,
wherein an index of refraction of the first transmission plate is larger than an index of refraction of the second transmission plate.

18. The method of claim 17, wherein the turning on of the optical unit to operate the reflective LC panel using the light output from the optical unit comprises providing light of the optical unit to a first side of the first transmission plate so that the incident light is totally internally-reflected by a boundary between the first transmission plate and the second transmission plate,
wherein the incident light travels through the first transmission plate to the reflective LC panel.

19. The method of claim 18, further comprising:
blocking light incident on the first side of the first transmission plate using an optical device disposed at the boundary between the optical unit and the second transmission plate,
wherein the optical device is at least one of a light screen tape, a light screen print material, and a light blocking tape.

20. The method of claim 15, further comprising:
determining whether a user inputs a command for turning the optical unit on or off; and
turning the optical unit on or off according the user input.
